(19) United States
(12) Patent Application Publication
(10) Pub. No.: US 2013/0083544 A1
(43) Pub. Date: Apr. 4, 2013

(54) LIGHT DIFFUSION FILM FOR LED LIGHTING

(71) Applicants: Hidemasa Hosoda, Kanagawa (JP); Karin Kuroiwa, Kanagawa (JP); Hiroyuki Mori, Kanagawa (JP); Kazuhide Hasegawa, Kanagawa (JP)

(72) Inventors: Hidemasa Hosoda, Kanagawa (JP); Karin Kuroiwa, Kanagawa (JP); Hiroyuki Mori, Kanagawa (JP); Kazuhide Hasegawa, Kanagawa (JP)

(73) Assignee: FUJIFILM CORPORATION, Tokyo (JP)

(21) Appl. No.: 13/637,891

(22) PCT Filed: Mar. 18, 2011
(86) PCT No.: PCT/JP2011/056640

§ 371 Date: Dec. 18, 2012

(30) Foreign Application Priority Data
Mar. 30, 2010 (JP) 2010-079877

(51) Int. Cl. F21V 11/00

(52) U.S. Cl. CPC F21V 11/00
USPC 362/355

(57) ABSTRACT

Provided is a light diffusion film for LED lighting that achieves a balance between concealment and light-utilization efficiency. The light diffusion film for LED lighting includes a sheet of substrate, an internal scattering layer and a surface shaping layer. The internal scattering layer contains a binder and particles; the mean particle diameter A of the particles is from 0.5 μm to 5.0 μm; the refractive index difference between the particles and the binder is from more than 0 to 0.15; and the content of the particles is from 10 parts by mass to 120 parts by mass with respect to 100 parts by mass of the binder.

### TECHNICAL FIELD

The present invention relates to a light diffusion film for LED lighting to which rigidity is provided while achieving a balance between concealment and light utilization efficiency.

### BACKGROUND ART

In the context of recent years' technological growth and optimization of energy consumption, LED is beginning to enter the field of lighting. As for what is greatly different from conventional lighting techniques, such as incandescent lamp and fluorescent lamp, the LED is a spot light source. Thus, to utilize the LED for lighting, there has been a demand for a light diffusion film having high concealment to eliminate the lamp image of a spot light source and also exhibiting high light utilization efficiency (for example, see JP-A-2009-32563). However, in general, as the concealment becomes higher, the efficiency is significantly reduced, so that it is difficult to make the balance between the concealment and the light utilization efficiency.

Heretofore, the diffusion film has been used mainly for backlight of TV and prevention of reflection. For example, there has been proposed a light diffusion sheet formed by laminating a light diffusion layer containing a binder resin and resin particles and having an uneven surface thereof, on a transparent substrate so as to exhibit high light diffusion properties and to enhance brightness in a front side direction even without the use of an expensive and fragile prism sheet or the like; in which a total light transmittance of the light diffusion sheet is 70.0% or more, a haze is 80% or more, and an image definition in transmission is from 21.0% to less than 25.0% (for example, see JP-A-2003-107214).

In addition, from the viewpoint of reducing the members of a backlight unit while maintaining basic optical properties in which diffusion properties and light-harvesting properties are excellent and high total light transmittance and brightness are obtainable, there has been proposed a light diffusion film in which a light diffusion layer including microparticles dispersed in a light-transmitting resin is formed on a surface of a transparent film, and a light-harvesting layer including microparticles embedded in the light-transmitting resin is formed on the light diffusion layer, in which an absolute value of a refractive index difference between the light-transmitting resin and the microparticles forming the light diffusion layer is 0.05 or more and a surface roughness of the light-harvesting layer is from 0.5 μm to 7 μm in terms of arithmetic mean roughness (for example, see JP-2007-233343).

In addition, as a glare-proof film suitable to reduce scintillation (screen glare) seen on high-definition display images, there has been disclosed a glare-proof film in which at least a glare-proof layer is laminated on a transparent substrate film, the glare-proof layer including two kinds of light-transmitting microparticles with different mean particle diameters dispersed in a light-transmitting resin and having a minute unevenness on an upper surface side of the layer; and in which smaller ones of the two kinds of light-transmitting microparticles has a mean particle diameter of from 20 to 70% of a mean particle diameter of larger ones thereof (for example, see JP-A-2004-4777).

However, as in JP-2003-107214 described above, when using the diffusion film for a backlight of a liquid crystal display of TV sets or the like, brightness in a frontal direction is regarded as important, whereas the elimination of a lamp image is not paid attention. Furthermore, in JP-2007-233343 described above, although high total light transmittance is intended to be obtained, the elimination of a lamp image is not focused. JP-2004-4777 described above has provided a technique of glare-proof film, which is used to suppress a portion with significantly high brightness (scintillation) by arranging the film before the image, where, in the first place, the elimination of a lamp image is not required, unlike a light diffusion film for lighting.

### SUMMARY OF INVENTION

### Problem to be Solved by the Invention

In view of the above problems, an object of the present invention is to provide a light diffusion film achieving the balance between high concealment and light utilization efficiency.

### Means for Solving Problem

Under the above-described circumstances, the present inventors made intensive and extensive investigations and found that a light diffusion film for LED lighting having high concealment and exhibiting less reduction in light utilization efficiency can be obtained by providing an internal scattering layer and a surface shaping layer on a substrate, setting a refractive index difference between particles and a binder incorporated in the internal scattering layer within a specific range, setting a mean particle diameter A of the particles within a specific range, and setting a content of the particles within a specific range.

Specifically, the present invention is as follows:

<1> A light diffusion film for LED lighting having a substrate, an internal scattering layer including at least particles and a binder, and a surface shaping layer including at least particles and a binder, in which, in the internal scattering layer, a refractive index difference ΔN between the particles and the binder satisfies the following formula (1), a mean particle diameter A of the particles satisfies the following formula (2), and a content of the particles is from 10 to 120 parts by mass with respect to 100 parts by mass of the binder:

0<ΔN≦0.15 Formula (1)

0.5 μm≦A≦5.0 μm. Formula (2)

<2> The light diffusion film for LED lighting according to the <1>, in which the particles included in the internal scattering layer have a particle size distribution (CV value) represented by the following formula (3) of 10% or less:

CV value=(particle diameter standard deviation)/(mean particle diameter)*100 (%). Formula (3)

<3> The light diffusion film for LED lighting according to the <1> or <2>, in which the particles included in the internal scattering layer are organic particles having a crosslinking structure.

<4> The light diffusion film for LED lighting according to any one of the <1> to <3>, in which the internal scattering layer includes a crosslinking agent.

<5> The light diffusion film for LED lighting according to any one of the <1> to <4>, in which the internal scattering layer includes ultrafine particles including inorganic particles.

<6> The light diffusion film for LED lighting according to any one of the <1> to <5>, in which a mean particle diameter B of the particles included in the surface shaping layer is larger than the mean particle diameter A of the particles included in the internal scattering layer.

<7> The light diffusion film for LED lighting according to any one of the <1> to <6>, in which, in the following order from a substrate side, the internal scattering layer and the surface shaping layer are provided on one surface of the substrate.

<8> The light diffusion film for LED lighting according to the <7>, in which a layer having a refractive index lower than a mean refractive index of the substrate is provided on an external surface at a surface side of the substrate on which the surface shaping layer is not provided.

<9> The light diffusion film for LED lighting according to the <7> or <8>, in which a layer having a refractive index lower than a refractive index of the particles included in the surface shaping layer is provided on an external surface of the surface shaping layer.

<10> The light diffusion film for LED lighting according to any one of the <1> to <6>, in which the internal scattering layer is provided on one surface of the substrate, and the surface shaping layer is provided on the other surface of the substrate.

<11> The light diffusion film for LED lighting according to the <10>, in which a layer having a refractive index lower than a mean refractive index of the internal scattering layer is provided on an external surface of the internal scattering layer.

<12> The light diffusion film for LED lighting according to the <10> or <11>, in which a layer having a refractive index lower than a refractive index of the particles included in the surface shaping layer is provided on an external surface of the surface shaping layer.

<13> The light diffusion film for LED lighting according to any one of the <1> to <12>, in which among the particles included in the surface shaping layer, particles having a mean particle diameter of 500 nm or more have a single peak in a particle size distribution.

<14> The light diffusion film for LED lighting according to any one of the <1> to <13>, in which the substrate is a PET film.

<15> The light diffusion film for LED lighting according to any one of the <1> to <14>, in which the binder in the internal scattering layer and the binder in the surface shaping layer each include at least one polymer selected from water-soluble polymers or water-dispersible polymers.

### Effect of Invention

According to the present invention, there is provided a light diffusion film for LED lighting having high concealment, whereby an LED lamp image is easily eliminated, and suppressing reduction in light utilization efficiency.

### BRIEF DESCRIPTION OF DRAWINGS

FIG. 1 is a schematic cross-sectional view showing one example of a light diffusion film for LED lighting according to the present invention.

FIG. 2 is a schematic cross-sectional view showing another example of the light diffusion film for LED lighting according to the present invention.

FIG. 3 is a view for explaining the mean value of brightness maximum value and the mean value of brightness minimum value in a method for evaluating concealment of a lamp image in Examples.

### DESCRIPTION OF EMBODIMENTS

A light diffusion film for LED lighting according to the present invention (hereinafter may be simply referred to as “a light diffusion film”) has a single sheet of substrate, an internal scattering layer, and a surface shaping layer. The internal scattering layer includes at least particles and a binder in which a refractive index difference ΔN between the particles and the binder satisfies the following formula (1); a mean particle diameter A of the particles satisfies the following formula (2); and a content of the particles is from 10 to 120 parts by mass with respect to 100 parts by mass of the binder:

0<ΔN≦0.15 Formula (1)

0.5 μm≦A≦5.0 μm. Formula (2)

It is not obvious the reason why the light diffusion film for LED lighting of the present invention has high concealment and suppresses light utilization efficiency reduction, but the reason is assumed as follows:

Reducing the refractive index difference between the particles and the binder included in the internal scattering layer to 0.15 or less and setting the mean particle diameter A of the particles within the specific range seem to reduce unnecessary reflection occurring when incident light from LED lighting is scattered on the internal scattering layer, whereby the return of the light to a LED lighting side (backward) is suppressed, resulting that the light efficiently travels to a visible side (forward) and therefore light utilization efficiency is improved.

In addition, it is assumed that, when the light from the LED lighting enters at an angle into the internal scattering layer with an angle, the light is appropriately refracted and brightness increases even in a region other than a spot directly above the LED lighting, thereby leading to the elimination of a lamp image and accordingly improvement of concealment. Furthermore, assumedly, providing the surface shaping layer seems to suppress the reflection of light upon entry of the light into the surface shaping layer and simultaneously increases scatterability, thereby synergistically achieving high concealment and light utilization efficiency.

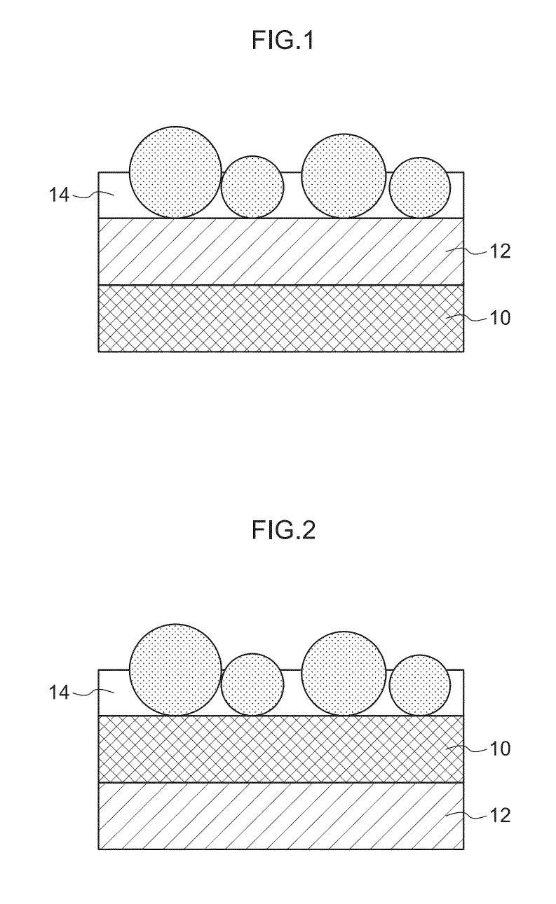

The light diffusion film of the present invention further includes another layer such as a back layer, as needed. FIG. 1 and FIG. 2 each show a schematic cross-sectional view of one example of the light diffusion film for LED lighting of the present invention.

In the light diffusion film shown in FIG. 1, an internal scattering layer 12 is provided on a substrate 10, and additionally, a surface shaping layer 14 is provided on the internal scattering layer 12. A first low refractive index layer (not shown in the drawing) may be provided on an external surface of the surface shaping layer 12, the first low refractive index layer having a refractive index lower than a refractive index of the particles included in the surface shaping layer. In addition, a second low refractive index layer (not shown in the drawing) may be provided on a surface of the substrate 10 where the internal scattering layer 12 is not provided, the second low refractive index layer having a refractive index lower than a refractive index of the substrate 10. The first low refractive index layer and the second low refractive index layer may be made of compositions different from one another, or may be layers made of the same composition.

In the light diffusion film for LED lighting shown in FIG. 2, the internal scattering layer 12 is provided on one of surfaces of the substrate 10 and the surface shaping layer 14 is provided on the other surface thereof. The first low refractive index layer (not shown in the drawing) may be provided on the external surface of the surface shaping layer 14, the first low refractive index layer having a refractive index lower than the refractive index of the particles included in the surface shaping layer 14. A third low refractive index layer (not shown in the drawing) may be provided on an external surface of the internal scattering layer 12, the third low refractive index layer having a refractive index lower than a refractive index of the internal scattering layer 12. The first refractive index layer and the third refractive index layer may be layers made of compositions different from one another, or may be layers made of the same composition.

Hereinafter, a detailed description will be given of members forming the light diffusion film for LED lighting of the present invention.

<Substrate>

The substrate is not particularly limited as long as it is a transparent sheet having a certain level of strength, and plastics or glass usually used as substrates can be appropriately selected for use according to the purpose. Particularly preferred are plastics.

As suitable plastics, there may be mentioned polyesters, polyolefins, and the like. Examples of the polyesters include polyethylene terephthalate (PET) and polyethylene naphthalate (PEN). Examples of the polyolefins include polyamide, polyether, polystyrene, polyesteramide, polycarbonate, polyphenylene sulfide, polyether ester, polyvinyl chloride, polyacrylate ester, and polymethacrylate ester.

Among them, polyester resins are preferable, and from the viewpoint of appropriateness for application by roll, more preferably, the substrate is made of polyethylene terephthalate (PET).

Polyethylene terephthalate (PET) used as the substrate is preferably one obtained by forming a polyester resin into a film shape by melt extrusion and molding it vertically and laterally by biaxial stretching. The biaxial stretching causes oriented crystallization, thereby improving strength and heat resistance of the substrate, so that the substrate made of polyethylene terephthalate becomes suitable to be used as the substrate of the light diffusion film for LED lighting.

Draw ratio is not particularly limited, but, the film is preferably stretched by from 1.5 to 7 times in the respective vertical and lateral directions, and more preferably stretched by approximately from 2 to 5 times. When the draw ratio is within the above range, there can be obtained a sufficient mechanical strength and an even thickness.

The method for producing the film and conditions for the film production to be used can be appropriately selected from known methods and known conditions.

The thickness of the substrate is not particularly limited as long as the thickness thereof is set within a commonly employed range for substrate, and can be appropriately selected according to the purpose. For example, the thickness of the substrate is preferably from 0.02 to 4.0 mm.

The surface(s) of the substrate may be subjected to an electro-discharge treatment to improve adhesion to the internal scattering layer and the surface shaping layer.

<Internal Scattering Layer>

The internal scattering layer includes particles and a binder for performing its light diffusion function. The refractive index difference ΔN between the particles and the binder satisfies the following formula (1). In addition, the mean particle diameter A of the particles satisfies the following formula (2). Furthermore, the content of the particles is from 10 to 120 parts by mass with respect to 100 parts by mass of the binder:

0<ΔN≦0.15 Formula (1)

0.5 μm≦A≦5.0 μm. Formula (2)

Hereinafter, a detailed description will be given of components included in the internal scattering layer.

(Particles)

The difference ΔN between the refractive index of the particles included in the internal scattering layer and the below-described refractive index of the binder satisfies the following formula (1):

0<ΔN≦0.15. Formula (1)

When the light diffusion film is designed such that concealment rate is maintained at the same level to eliminate a lamp image, if the refractive index difference between the particles and the binder included in the internal scattering layer is more than 0.15, light utilization efficiency is significantly reduced.

Specifically, the refractive index of the particles included in the internal scattering layer is preferably from 1.30 to 1.80.

Regarding the particles included in the internal scattering layer, the mean particle diameter A satisfies the following formula (1), and more preferably, the mean particle diameter A is within a range of from 1.0 μm to 5.0 μm:

0.5 μm≦A≦5.0 μm. Formula (2)

When the light diffusion film is designed such that the concealment rate is maintained at the same level to eliminate the lamp image, if the mean particle diameter A of the particles included in the internal scattering layer is less than 0.5 μm, light utilization efficiency is significantly reduced or scattering ability is reduced and does not contribute to concealment. If the mean particle diameter A is more than 5.0 μm, light utilization efficiency is also reduced.

The material of the particles is not particularly limited and can be appropriately selected according to the purpose. Suitable examples of the particles include organic particles, such as polymethyl methacrylate resin particles, melamine resin particles, polystyrene resin particles, and silicone resin particles. These may be used alone or in a combination of two or more kinds thereof.

Preferably, the organic particles have a crosslinking structure. In addition, the organic particles may have coated surfaces. For example, suitably used organic particles are those having silica-coated surfaces, hydrophilically treated, or hydrophobically treated surfaces, according to the kind of application liquid.

In the particles included in the internal scattering layer, a particle size distribution CV value represented by the following formula (3) is preferably 10 or less, and more preferably 5 or less, from the viewpoint of further increasing the light utilization efficiency:

CV value=(particle diameter standard deviation)/(mean particle diameter)*100 (%). Formula (3)

The mean particle diameter of the particles is a volume mean particle diameter measured using a particle distribution measurement apparatus (such as MULTISIZER II manufactured by Coulter Electronics Corp.).

The amount of the particles added is from 10 to 120 parts by mass with respect to 100 parts by mass of the binder described below. If the amount of the particles added with respect to 100 parts by mass of the binder is less than 10 parts by mass, it is difficult to obtain intended concealment, whereas if it is more than 120 parts by mass, it is difficult to obtain favorable efficiency. The amount of the particles added is preferably from 10 to 110 parts by mass, and more preferably from 10 to 105 parts by mass, with respect to 100 parts by mass of the binder.

(Binder)

In the present invention, the binder means an entire solid content (including ultrafine particles described below) except for the above-described particles in the internal scattering layer, and specifically, the binder includes resin, ultrafine particles, and other additives.

Specifically, the binder has a refractive index of preferably from 1.40 to 1.70, and more preferably from 1.4 to 1.6.

—Resin—

Desirably, the resin included as the binder is, for example, at least one resin selected from water-soluble polymers and water-dispersible polymers when water is used as a dispersion medium of an internal scattering layer application liquid. As a suitable binder resin, there may be mentioned a homopolymer, a copolymer, or the like.

Examples of the homopolymer or the copolymer include (meth)acrylate resin, polyvinyl acetate, ethylene-vinyl acetate copolymer resin, polyvinyl chloride resin, polyvinyl chloride-vinylidene chloride copolymer resin, butyral resin, silicone resin, polyester resin, polyvinylidene fluoride, nitrocellulose resin, styrene resin, styrene-acrylonitrile copolymer resin, polyurethane resin, polyethylene, polypropylene, chlorinated polyethylene, and rosin derivatives.

The water-soluble and/or water-dispersible polymer(s) is/are not particularly limited and can be appropriately selected according to the purpose.

Examples of the water-soluble or water-dispersible polymers include polyvinyl alcohol, methylcellulose, gelatin, polyester resins, polyurethane resins, acrylic resins, amino resins, epoxy resins, and styrene-butadiene copolymers. Among them, acrylic resin-type, polyester resin-type, or polyurethane resin-type water-dispersible polymers are preferable. These may be used alone or in a combination of two or more kinds thereof. In addition, a polymer capable of reacting with a crosslinking agent is preferably used. For example, a polymer having a hydroxyl group, an amino group, a carboxyl group, or the like may be used. Furthermore, a substituent or the like, such as a sulfonic acid group, a hydroxyl group, a carboxylic acid group, an amino group, an amide group, or an ether group is preferably incorporated in the water-dispersible polymers. These water-dispersible polymers may be used alone or in a combination thereof.

In the internal scattering layer, furthermore, preferably, a crosslinking agent is added for film curability so as to provide damage resistance against handling, solvent resistance against a solvent for wiping off dust or stain adhered to the layer surface, and adhesion to the substrate when stamping the light diffusion film for LED lighting into a predetermined shape.

—Crosslinking Agent—

The crosslinking agent is preferably a carbodiimide compound or an isocyanate compound, and more preferably a carbodiimide compound.

The carbodiimide compound used in the present invention has a carbodiimide group in its molecule, and for example, forms a chemical structure, such as a carbamoyl amide bond by a reaction of the carbodiimide group with a carboxyl group of a polyester resin or an isourea bond by a reaction of the carbodiimide group with a hydroxyl group of the polyester resin, respectively. The chemical structure also includes a guanidine structure produced by a reaction of the carbodiimide group with an amino group.

As commonly available commercial products, there can be used CARBODILITE E series (emulsion type), V series (aqueous type), which are manufactured by Nisshinbo Industries, Inc., and the like.

The isocyanate compound to be used is at least any of aliphatic isocyanate compounds or cyclic aliphatic isocyanate compounds having at least two, and preferably, three or more functional groups in their molecules, and aromatic multifunctional isocyanate compounds. The isocyanate compounds have been described in “Polyurethane Resin Handbook” (edited by Keiji Iwata, published by Nikkan Kogyo Shimbun Ltd., 1987).

These crosslinking agents may be used alone or in a combination of two or more kinds thereof.

—Ultrafine Particles—

Furthermore, other particles, such as ultrafine particles made of inorganic particles may be added in the internal scattering layer. The ultrafine particles can improve application suitability and can control the refractive index of the binder.

The ultrafine particles are not particularly limited, and a commonly used substance can be appropriately selected to be dispersed, according to the purpose. Examples of the substance include silica, calcium carbonate, alumina, zirconia, and titanium oxide.

A particle diameter of the ultrafine particles is preferably within a range of from 0.005 to 0.150 μm, and more preferably within a range of from 0.005 to 0.100 μm.

An amount of the ultrafine particles added in the internal scattering layer is not particularly limited and can be appropriately selected according to the situation. For example, a preferable amount of the ultrafine particles added is from 1 to 20% by mass.

—Solvent—

The solvent used in the internal scattering layer application liquid is not particularly limited and can be appropriately selected for use from commonly used solvents, such as water and organic solvents.

Examples of the organic solvents include ketones, ethers, alcohols, esters, polyalcohol derivatives, and carboxylic acids.

The internal scattering layer is formed by applying and then drying the internal scattering layer application liquid on an adhesive layer. The internal scattering layer to be formed may be only one layer or may include two or more layers.

The method for applying the internal scattering layer application liquid is not particularly limited and can be appropriately selected according to the purpose. The application method can be performed by a commonly used application means, such as a spin coater, a roll coater, a bar coater, and a curtain coater.

The method for drying the internal scattering layer application liquid is not particularly limited and a commonly used method can be appropriately selected according to the kind of solvent to be used. For example, when using water as the solvent, drying temperature is preferably from 90 to 140° C., and more preferably from 100 to 140° C. from the viewpoint of drying in a short time and without any damage to the material. Drying at a temperature within the above range does not take a long time and thus damage to the material can be suppressed. Time for drying is, for example, preferably from 10 seconds to 5 minutes, and more preferably from 1 to 3 minutes.

(Physical Properties and the Like)

A thickness of the internal scattering layer is preferably from 1 to 20 μm from the viewpoint of achieving the effects of light scattering efficiency.

<Surface Shaping Layer>

The surface shaping layer includes at least particles and a binder.

(Binder)

The binder included in the surface shaping layer may be the same as the binder described with respect to the internal scattering layer.

(Particles)

The material of the particles included in the surface shaping layer is not particularly limited and can be appropriately selected according to the purpose. Suitable examples of the particles include organic particles, such as polymethyl methacrylate resin particles, melamine resin particles, polystyrene resin particles, and silicone resin particles. These may be used alone or in a combination of two or more kinds thereof.

The surface shaping layer includes particles having a mean particle diameter B of 500 nm or more, preferably a mean particle diameter B of from 0.5 μm to 50 μm, and more preferably a mean particle diameter B of from 3 μm to 20 μm.

In addition, among the particles included in the surface shaping layer, the particles having the mean particle diameter of 500 nm or more may have a single peak or two or more peaks in the particle size distribution. In the light diffusion film of the present invention including the internal scattering layer, even when the surface shaping layer is formed by addition of a single kind of particles, there can be obtained the same effect as in the formation of the surface shaping layer using two or more kinds of particles in combination. Accordingly, the light diffusion film of the present invention is advantageous to simplify a production process.

The mean particle diameter B of the particles included in the surface shaping layer is preferably larger than the mean particle diameter A of the particles included in the internal scattering layer from the viewpoint that a hue change in a white LED light source is reduced. Specifically, the mean particle diameter B is preferably larger than the mean particle diameter A by 1 μm or more, and more preferably larger than the mean particle diameter A by 3 μm or more.

The amount of the particles added is preferably from 5 to 400 parts by mass, and more preferably from 50 to 300 parts by mass, with respect to 100 parts by mass of the binder resin. When the amount of the particles added is within the above range, dispersibility of the particles in the binder becomes favorable and, thus, the particles sufficiently act as a light diffusion agent.

(Other Additives)

In the surface shaping layer, as in the internal scattering layer, furthermore, a crosslinking agent, ultrafine particles, a solvent, or the like may be added. The kinds of the crosslinking agent, the ultrafine particles, and the solvent added into the surface shaping layer, respectively, are the same as the crosslinking agent, the ultrafine particles, and the solvent described regarding the internal scattering layer.

In addition, the ultrafine particles included in the surface shaping layer mean those having a mean particle diameter smaller than that of the particles described above.

An amount of the ultrafine particles added in the surface shaping layer is not particularly limited and can be appropriately selected according to the situation to obtain an intended total light transmittance and an intended half-value angle, as described above. For example, the amount of the ultrafine particles added is preferably from 1 to 20% by mass.

(Physical Properties and the Like)

A thickness of the surface shaping layer is preferably from 2 to 30 μm, and more preferably from 2 to 20 μm from the viewpoint of achieving the effect of light scattering.

<Low Refractive Index Layer>

The light diffusion film for LED lighting of the present invention may include a low refractive index layer on a surface of an outermost layer. Herein, as the low refractive index layer, there may be mentioned a first low refractive index layer provided further on an external surface of the surface shaping layer when the surface shaping layer is provided as the outermost layer, a second low refractive index layer provided on an external surface of the substrate when the substrate is provided as the outermost layer, or a third low refractive index layer provided on an external surface of the internal scattering layer when the internal scattering layer is provided as the outermost layer. In addition, the first refractive index layer, the second refractive index layer, and the third refractive layer may be made of compositions different from one another, or may be made of the same composition.

By including such a low refractive index layer as the outermost layer, interfacial reflection between air and the outermost layer can be suppressed, thereby enabling the improvement of light efficiency.

The refractive index of the first low refractive index layer is lower than the refractive index of the particles included in the surface shaping layer provided in contact with the first low refractive index layer. Specifically, the refractive index of the first low refractive index layer is preferably smaller than the refractive index of the particles included in the surface shaping layer by 0.01 or more, more preferably by 0.05 or more, and still more preferably by 0.10 or more.

Specifically, the refractive index of the first low refractive index layer is preferably from 1.30 to 1.50, and more preferably from 1.30 to 1.45.

The refractive index of the second low refractive index layer is lower than the refractive index of the substrate provided in contact with the second low refractive index layer. Specifically, the refractive index of the first low refractive index layer is preferably smaller than the refractive index of the substrate by 0.10 or more, and more preferably smaller than that of the substrate by 0.15 or more.

Specifically, the refractive index of the second low refractive index layer is preferably from 1.30 to 1.50, and more preferably from 1.30 to 1.45.

The refractive index of the third low refractive index layer is lower than the refractive index of the internal scattering layer provided in contact with the third low refractive index layer. Specifically, the refractive index of the first low refractive index layer is smaller than the refractive index of the internal scattering layer, preferably by 0.01 or more, more preferably by 0.05 or more, and still more preferably by 0.10 or more.

Specifically, the refractive index of the third low refractive index layer is preferably from 1.30 to 1.50, and more preferably from 1.30 to 1.45.

Examples of commercially available products as material used for the low refractive index layer include fluorine-based materials, such as CYTOP CTL-107 MK (refractive index: 1.34) manufactured by Asahi Glass Co., Ltd., porous films such as silica aerogel, and materials containing micro-size hollow particles or the like.

A thickness of the low refractive index layer is preferably from0.05 to 2 μm, and more preferably from 0.05 to 1 μm.

<Method for Producing Light Diffusion Film for LED Lighting>

The method for producing the light diffusion film for LED lighting of the present invention is not particularly limited as long as it is a method capable of forming the light diffusion film for LED lighting having the above-described structure. Hereinafter, a description will be given of one example of the method for producing the light diffusion film for LED lighting.

In the light diffusion film for LED lighting of the present invention shown in FIG. 1, first, the above-described internal scattering layer application liquid including at least the particles and the binder is applied onto the substrate, thereby forming the internal scattering layer. Additionally, a surface shaping layer application liquid including at least particles and a binder is applied onto the internal scattering layer, thereby forming the surface shaping layer.

In addition, in the light diffusion film for LED lighting of the present invention shown in FIG. 2, first, the above-described internal scattering layer application liquid including at least the particles and the binder is applied on the substrate, thereby forming the internal scattering layer. Then, on the surface of the substrate where the internal scattering layer is not provided, a surface shaping layer application liquid including at least particles and a binder is applied to form the surface shaping layer.

In the light diffusion film for LED lighting of the present invention shown in FIG. 2, the surface shaping layer may be first formed, and then, the internal scattering layer may be formed.

When providing the low refractive index layer on the light diffusion film for LED lighting of the present invention, the film is immersed in a low refractive index layer application liquid or the low refractive index layer liquid is applied onto the film, and then the film is dried.

<Intended Use>

The light diffusion film for LED lighting of the present invention can be suitably used for apparatuses using LED lighting because of the advantages thereof. In addition, for example, the light diffusion film of the invention can be used as a light diffusion film in a backlight unit of a liquid crystal display used in mobile phones, PC monitors, TV sets, liquid crystal projectors, or the like.

Using the light diffusion film for LED lighting of the present invention allows for balancing between high concealment and light utilization efficiency. Therefore, in LED lighting using the light diffusion film, a lamp image is eliminated and light utilization efficiency is maintained at high level.

Herein, the light utilization efficiency in the present specification means a measured value (%) obtained after insertion of the film, provided that a total luminous flux obtained under the condition of non-insertion of the film is 1. At present, the LED, just as a single element, has begun to achieve performance exceeding a conventional fluorescent light. However, when the LED is mounted as an actual lighting device, light utilization efficiency is reduced depending on thermoelectric conversion efficiency and the shape of the device. As a result, the LED has not yet caught up with fluorescent light acting as a conventional highly efficient lighting. Even if a difference in the light utilization efficiency is just 1%, it will be understood as a significantly large difference in practical use, since superiority of the LED will be shown in the future not only in terms of an environmental matter in which the LED is mercury-free unlike fluorescent light using mercury, but also in terms of energy consumption as light efficiency to demonstrate a great solicitation power against the conventional lighting.

### EXAMPLES

Hereinafter, Examples of the present invention will be described, but the invention is not limited thereto at all. In the description below, the term “parts” and “%” mean “parts by mass” and “% by mass” unless otherwise specified.

### Example 1

### <Production of Film 1>

On a PET film (refractive index: 1.67) with a thickness of 300 μm was applied an internal scattering layer application liquid having the following composition by a wire bar, and the product was thermally cured in an oven at 130° C. for 2 minutes.

(Composition of Internal Scattering Layer Application Liquid 1)

Distilled water: 80 parts by mass

Surfactant (NAROACTY CL-95, manufactured by Sanyo Chemical Industries, Ltd.): 5 parts by mass

Particles (OPTOBEADS 2000M, silica-coated melamine particles, mean particle diameter: 2 μm, refractive index: 1.65, manufactured by Nissan Chemical Industries, Ltd.): 201 parts by mass

Ultrafine particle dispersion liquid (SNOWTECHS C, silica particles, mean particle diameter: 0.01 to 0.02 μm, solid content: 20%, manufactured by Nissan Chemical Industries, Ltd.): 333 parts by mass

Water-dispersible polymer (polyurethane resin, NeoRez R-600, solid content: 33%, manufactured by DMS NeoResins Inc.): 368 parts by mass

Crosslinking agent (CARBODILITE V-02-L2, solid content: 40%, manufactured by Nisshinbo Industries, Inc.): 12 parts by mass

A part of the obtained coat film was separated and the thickness of the film was measured by a step gauge (manufactured by Dektak Veeco Co. Ltd.) under conditions adjusted as needed to obtain a mean film thickness of 4 μm. Herein, regarding the film thickness, arbitrary three points of the film were each separated and a difference in level between the substrate surface and the coat film was each measured, from which a mean value was determined. In each measurement, a surface of the coated film was measured at a distance of 500 μm to calculate a mean film thickness of the surface with unevenness. Hereinafter, in the Examples, the film thickness was measured by this method.

Additionally, a surface shaping layer application liquid 1 having the following composition was applied onto the formed internal scattering layer by a wire bar, and the product was thermally cured in the oven at 130° C. for 2 minutes to produce film 1. The mean value of a total film thickness obtained by summing the thicknesses of the internal scattering layer and the surface shaping layer was measured by the above method to obtain 10 μm.

(Composition of Surface Shaping Layer Application Liquid 1)

Distilled water: 244 parts by mass

Surfactant (NAROACTY CL-95, manufactured by Sanyo Chemical Industries, Ltd.): 5 parts by mass

Particles (SBX-8, crosslinking polystyrene particles, mean particle diameter: 8 μm, refractive index: 1.59, manufactured by Sekisui Chemical Company, Ltd.): 264 parts by mass

Ultrafine particle dispersion solution (SNOWTECHS C, silica particles, mean particle diameter: from 0.01 to 0.02 μm, solid content: 20%, manufactured by Nissan Chemical Industries, Ltd.): 238 parts by mass

Water-dispersible polymer (polyurethane, NeoRez R-600, resin, solid content: 33%, manufactured by DMS NeoResins Inc.): 237 parts by mass

Crosslinking agent (CARBODILITE V-02-L2, solid content: 40%, manufactured by Nisshinbo Industries, Inc.): 13 parts by mass

### Example 2

### <Production of Film 2>

An internal scattering layer application liquid 2 shown below was applied by a wire bar onto a PET film (refractive index: 1.67) with the thickness of 300 μm, and the product was thermally cured in the oven at 130° C. for 2 minutes. A mean film thickness of the formed internal scattering layer was 12 μm.

(Composition of Internal Scattering Layer Application Liquid 2)

Distilled water: 80 parts by mass

Surfactant (NAROACTY CL-95, manufactured by Sanyo Chemical Industries, Ltd.): 5 parts by mass

Particles (TOSPEARL, silicone particles, mean particle diameter: 4.5 μm, refractive index: 1.45, manufactured by Momentive Performance Materials, Inc.): 201 parts by mass

Ultrafine particle dispersion solution (SNOWTECHS C, silica particles, mean particle diameter: from 0.01 to 0.02 μm, solid content: 20%, manufactured by Nissan Chemical Industries, Ltd.): 333 parts by mass

Water-dispersible polymer (polyurethane resin, NeoRez R-600, solid content: 33%, manufactured by DMS NeoResins Inc.): 368 parts by mass

Crosslinking agent (CARBODILITE V-02-L2, solid content: 40%, manufactured by Nisshinbo Industries, Inc.): 12 parts by mass

In addition, the surface shaping layer application liquid 1 was applied by a wire bar onto the formed internal scattering layer, and the product was thermally cured in the oven at 130° C. for 2 minutes to produce a film 2. The mean value of a total film thickness obtained by summing the thicknesses of the internal scattering layer and the surface shaping layer was measured by the above method to obtain 18 μm.

### Example 3

### <Production of Film 3>

The internal scattering layer application liquid 1 was applied by a wire bar onto a PET film (refractive index: 1.67) with the thickness of 300 μm, and the product was thermally cured in the oven at 130° C. for 2 minutes. The formed internal scattering layer had a mean film thickness of 4 μm.

Furthermore, on a surface of the PET film opposite to the surface where the internal scattering layer application liquid was applied, the surface shaping layer application liquid 1 was applied by a wire bar, and the product was thermally cured in the oven at 130° C. for 2 minutes to produce a film 3. The surface shaping layer had a mean film thickness of 6 μm.

### Example 4

### <Production of Film 4>

The film 1 was produced in the same manner as in Example 1. On a substrate surface of the film 1 was spin-coated a solution prepared by diluting CYTOP (CTL-107 MK, refractive index: 1.34, manufactured by Asahi Glass Co., Ltd.) to 4 times with a dilution solution for the same product, and then, the film was dried in the oven at 100° C. for 30 minutes to produce a film 4. In the film 4, the layer made of CYTOP was formed on the substrate as the topmost surface.

### Example 5

### <Production of Film 5>

The film 1 was produced in the same manner as in Example 1. On both surfaces of the film 1 was spin-coated a solution prepared by diluting CYTOP (CTL-107 MK, refractive index: 1.34, manufactured by Asahi Glass Co., Ltd.) to 4 times with the dilution solution for the same product, and then, the film was dried in the oven at 100° C. for 30 minutes to produce a film 5.

### Example 6

### <Production of Film 6>

The film 3 was produced in the same manner as in Example 3. On both surfaces of the film 3 were spin-coated a solution prepared by diluting CYTOP (CTL-107 MK, refractive index: 1.34, manufactured by Asahi Glass Co., Ltd.) to 4 times with the dilution solution for the same product, and then, the film was dried in the oven at 100° C. for 30 minutes to produce a film 6.

### Example 7

### <Production of Film 7>

On a PET film (refractive index: 1.67) with the thickness of 300 μm was applied an internal scattering layer application liquid having the following composition by a wire bar, and the product was thermally cured in the oven at 130° C. for 2 minutes.

(Composition of Internal Scattering Layer Application Liquid 3)

Distilled water: 97 parts by mass

Surfactant (NAROACTY CL-95, manufactured by Sanyo Chemical Industries, Ltd.): 6 parts by mass

Particles (OPTOBEADS 2000M, silica-coated melamine particles, mean particle diameter: 2 μm, refractive index: 1.65, manufactured by Nissan Chemical Industries, Ltd.): 26 parts by mass

Ultrafine particle dispersion solution (SNOWTECHS C, silica particles, mean particle diameter: 0.01 to 0.02 μm; solid content: 20%, manufactured by Nissan Chemical Industries, Ltd.): 408 parts by mass

Water-dispersible polymer (NeoRez R-600, polyurethane resin, solid content: 33%, manufactured by DMS NeoResins Inc.): 448 parts by mass

Crosslinking agent (CARBODILITE V-02-L2, solid content: 40%, manufactured by Nisshinbo Industries, Inc.): 15 parts by mass

A part of the obtained coat film was separated and the thickness of the film was measured by the step gauge (manufactured by Dektak Veeco Co. Ltd.) under conditions adjusted as needed to obtain the mean film thickness of 4 μm.

Additionally, the surface shaping layer application liquid 1 was applied by a wire bar onto the formed internal scattering layer, and the product was thermally cured in the oven at 130° C. for 2 minutes to produce a film 7. The mean value of a total film thickness obtained by summing the thicknesses of the internal scattering layer and the surface shaping layer was measured by the above method to obtain 10 μm.

### Comparative Example 1

### <Production of Comparative Film 1>

an internal scattering layer application liquid 4 having the following composition was applied by a wire bar onto a PET film (refractive index: 1.67) with the thickness of 300 μm, and the product was thermally cured in the oven at 130° C. for 2 minutes. The formed internal scattering layer had the mean film thickness of 4 μm.

(Internal Scattering Layer Application Liquid 4)

Distilled water: 83 parts by mass

Surfactant (DEMOL EP, solid content 24%, manufactured by Kao Chemicals): 24 parts by mass

Particles (CR-50, titanium oxide particles, mean particle diameter: 0.3 μm, refractive index: 2.6, manufactured by Ishihara Sangyo Kaisya, Ltd.): 48 parts by mass

Ultrafine particle dispersion solution (SNOWTECHS C, silica particles, mean particle diameter: from 0.01 to 0.02 μm, solid content: 20%, manufactured by Nissan Chemical Industries, Ltd.): 395 parts by mass

Water-dispersible polymer (polyurethane resin, NeoRez R-600, solid content: 33%, manufactured by DMS NeoResins Inc.): 436 parts by mass

Crosslinking agent (CARBODILITE V-02-L2, solid content: 40%, manufactured by Nisshinbo Industries, Inc.): 14 parts by mass

The surface shaping layer application liquid 1 was applied by a wire bar onto the formed internal scattering layer, and the product was thermally cured in the oven at 130° C. for 2 minutes to produce comparative film 1. The mean value of a total film thickness obtained by summing the thicknesses of the internal scattering layer and the surface shaping layer was measured by the above method to obtain 10 μm.

### Comparative Example 2

### <Production of Comparative Film 2>

An internal scattering layer application liquid 5 having the following composition was applied by a wire bar onto a PET film (refractive index: 1.67) with the thickness of 300 μm, and the product was thermally cured in the oven at 130° C. for 2 minutes. The mean film thickness of the formed internal scattering layer was 12 μm.

(Internal Scattering Layer Application Liquid 5)

Distilled water: 80 parts by mass

Surfactant (NAROACTY CL-95, manufactured by Sanyo Chemical Industries, Ltd.): 5 parts by mass

Particles (OPTOBEADS 6500M, silica-coated melamine particles, mean particle diameter: 6.5 μm, refractive index: 1.65, manufactured by Nissan Chemical Industries, Ltd.): 201 parts by mass

Ultrafine particle dispersion solution (SNOWTECHS C, silica particles, mean particle diameter: from 0.01 to 0.02 μm, solid content: 20%, manufactured by Nissan Chemical Industries, Ltd.): 333 parts by mass

Water-dispersible polymer (polyurethane resin, NeoRez R-600, solid content: 33%, manufactured by DMS NeoResins Inc.): 368 parts by mass

Crosslinking agent (CARBODILITE V-02-L2, solid content: 40%, manufactured by Nisshinbo Industries, Inc.): 12 parts by mass

A surface shaping layer application liquid 2 shown below was applied by a wire bar onto the formed internal scattering layer, and the product was thermally cured in the oven at 130° C. for 2 minutes to produce a comparative film 2. The mean value of a total film thickness obtained by summing the thicknesses of the internal scattering layer and the surface shaping layer was measured by the above method to obtain 22 μm.

(Surface Shaping Layer Application Liquid 2)

Distilled water: 244 parts by mass

Surfactant (NAROACTY CL-95, manufactured by Sanyo Chemical Industries, Ltd.): 5 parts by mass

Particles (SBX-12, crosslinking polystyrene particles, mean particle diameter: 12 μm, refractive index: 1.59, manufactured by Sekisui Chemical Company, Ltd.): 264 parts by mass

Ultrafine particle dispersion liquid (SNOWTECHS C, silica particles, mean particle diameter: from 0.01 to 0.02 μm, solid content: 20%, manufactured by Nissan Chemical Industries, Ltd.): 238 parts by mass

Water-dispersible polymer (polyurethane resin, NeoRez R-600, solid content: 33%, manufactured by DMS NeoResins Inc.): 237 parts by mass

Crosslinking agent (CARBODILITE V-02-L2, solid content: 40%, manufactured by Nisshinbo Industries, Inc.): 13 parts by mass

### Comparative Example 3

### <Production of Comparative Film 3>

A light diffusion layer film was formed on a PET film (refractive index: 1.67) with the thickness of 300 μm by using the same formulation and the same production method as those in Example 1 of JP-A-2007-233343.

### Comparative Example 4

### <Production of Comparative Film 4>

A light diffusion layer film was formed on a PET film (refractive index: 1.67) with the thickness of 300 μm by using the same formulation and the same production method as those in Example 1 of JP-A-2004-4777.

In addition, styrene beads with a thickness of 1.3 μm used had a CV value of 10%. The content ratio of the particles was 6.7 parts by mass with respect to 100 parts by mass of the binder.

[Measurement]

The following methods were used to measure the refractive indexes of the binders and the refractive indexes and particle diameters of the particles used for the film productions, and the refractive indexes of the formed internal scattering layers.

<Measurement of Refractive Index of Binder>

The refractive index of the binder in the internal scattering layer was measured as follows: a composition excluding the particles from each of the above-described internal scattering layer application liquids was prepared, and then, by using a bar coat, a layer with a thickness of 40 μm made of the composition was formed to perform refractive index measurement by a multi-wavelength Abbe refractometer (DR-M2 manufactured by Atago Co., Ltd). Measurement wavelength was 589 nm and measurement temperature was 25° C.

<Measurement of Refractive Index of Particles>

In addition, the refractive index of the particles was measured as follows: particles were placed on a slide glass and an organic compound or a mixture thereof each having a known refractive index (a compound for measurement) was added to the particles. The obtained mixture product was sandwiched by a cover glass and observed at 25° C. through a (transmission) optical microscope to determine the kind or composition of the compound for measurement in a case in which the particles were most difficult to observe. Then, the refractive index of the determined compound for measurement was measured by the multi-wavelength Abbe refractometer (DR-M2 manufactured by Atago Co., Ltd). The measurement wavelength was 589 nm and the measurement temperature was 25° C.

<Calculation of Refractive Index of Internal Scattering Layer>

A mean refractive index of the internal scattering layer was calculated from the refractive index of the binder and the refractive index of the particles obtained by the measurement methods described above.

<Measurement of Particle Size Distribution of Particles>

According to the method described above, the particle size distribution Cv value of the particles was measured.

<Method for Measuring Particle Diameter>

The particle diameter to be measured herein refers to a volume mean particle diameter. Herein, the volume mean particle diameter was measured by the particle size distribution apparatus (for example, MULTISIZER II manufactured by Coulter Electronics Corp). Regarding strongly aggregated particles, such as titanium oxide particles, an image of the electronic microscope was used as needed to measure and calculate a particle diameter thereof.

[Evaluation]

Next, regarding the produced films of the Examples and the Comparative Examples, lamp image concealment and light utilization efficiency were evaluated by the following methods. Table 1 shows the results.

<Evaluation of Lamp Image Concealment>

Evaluation was conducted by inserting each film in place of a diffusion plate attached to LED lighting (DL-N002N manufactured by Sharp Corporation). The each light diffusion film was placed in such a manner that the surface shaping layer was positioned on a farther side from the lighting device.

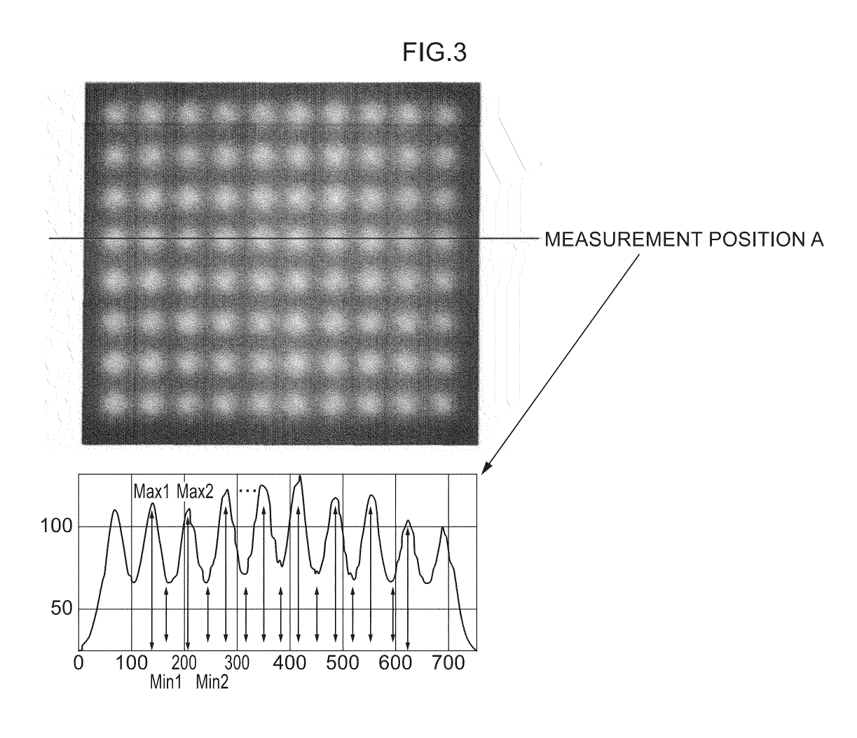

The evaluation of lamp image concealment was performed as follows: an image was taken by a CMOS camera (INFINITY manufactured by Lumenera Corporation) from a position of approximately 1 m straight-ahead from the real device equipped with the sheet. The image was imported into an image processing software to measure the mean of brightness maximum value (mean maximum value) and the mean of brightness minimum value (mean minimum value) of a portion excluding extreme ends of brightness value cut out in a certain axial direction. The lamp image concealment was defined as a ratio of the mean minimum value to the mean maximum value. FIG. 3 shows one example in which the brightness maximum value and the brightness minimum value were measured at a measurement position A in a certain axial direction in a plane of the light diffusion film.

In visual evaluation, when a ratio of the mean minimum value to the mean maximum value exceeded 90%, lamp image became hardly visible.

<Evaluation of Light Utilization Efficiency>

Evaluation was conducted by inserting each film in place of a diffusion plate attached to LED lighting (DL-N002N manufactured by Sharp Corporation). The each light diffusion film was placed in such a manner that the surface shaping layer was positioned on a farther side from the lighting device.

Based on the common industrial standards (JIS-C8152 (ver. 2007)), evaluation was performed by an integrating sphere type light transmittance measurement apparatus. In the evaluation, provided that a total luminous flux obtained under the condition of non-insertion of the film was 1, a measure value (%) obtained after the insertion of the film was determined as light utilization efficiency.

TABLE 1

| | | | | Surface | | |
|---|---|---|---|---|---|---|
| | Internal scattering layer | | | shaping | | |
| | | Particle | | layer | | |
| | | size | | Mean | | |
| | Mean | distribution | | particle | Evaluation | Light |
| | particle | Cv Value | | diameter | Concealment | Utilization |
| | diameter A [μm] | [%] | ΔN | B [μm] | [%] | [%] |
| Example 1 | 2 | 4 | 0.14 | 8 | 93 | 89 |
| Example 2 | 4.5 | 10 | 0.06 | 8 | 92 | 89 |
| Example 3 | 2 | 4 | 0.14 | 8 | 93 | 89 |
| Example 4 | 2 | 4 | 0.14 | 8 | 93 | 90 |
| Example 5 | 2 | 4 | 0.14 | 8 | 93 | 91 |
| Example 6 | 2 | 4 | 0.14 | 8 | 93 | 90 |
| Example 7 | 2 | 4 | 0.14 | 8 | 90 | 91 |
| Comparative | 0.3 | 30 | 1.1 | 8 | 93 | 81 |
| Example 1 | | | | | | |
| Comparative | 6.5 | 8 | 0.14 | 12 | 93 | 85 |
| Example 2 | | | | | | |
| Comparative | 5.2 | 30 | 0.17 | 13.5 | 91 | 85 |
| Example 3 | | | | | | |
| Comparative | 1.3 | 10 | 0.1 | 5, | 10 | 93 |
| Example 4 | | | | 3.5 | | |

The results of Table 1 show that reduction in light utilization efficiency of the light diffusion films for LED lighting of Examples 1 to 7 have been suppressed in spite of the design of high concealment. In contrast, it is seen that, in Comparative Example 1 using the particles with the mean particle diameter of 0.3 μm included in the internal scattering layer, Comparative Example 2 using the particles with the mean particle diameter of 6.5 μm, and Comparative Example 3 using the particles with the mean particle diameter of 5.2 μm, when the light diffusion film is designed such that the concealment is maintained at the same level, the light utilization efficiency is reduced.

In addition, it is found that, in Comparative Example 1 and Comparative Example 3, the value of ΔN is large and the light utilization efficiency is reduced. It is also found that, in the film of Comparative Example 4 used for glare proof purpose, due to the purpose, the amount of the particles included in the internal scattering layer is small and thus concealment are significantly low.

Accordingly, it is seen that a balance between the concealment and the light utilization efficiency in the light diffusion film for LED lighting as a spot light source is achieved by a synergistic combination of the refractive index difference ΔN between the particles and the binder in the internal scattering layer, the mean particle diameter of the particles, and the content of the particles.

The disclosure of Japanese Patent Application No. 2010-79877 is incorporated herein by reference in its entirety.

All documents, patent applications, and technical standards described in the present specification are incorporated herein by reference to the same extent as if each individual document, patent application, or technical standard were specifically and individually indicated to be incorporated by reference.

1. A light diffusion film for LED lighting comprising a substrate, an internal scattering layer comprising at least first particles and a first binder, and a surface shaping layer comprising at least second particles and a second binder,
wherein, in the internal scattering layer, a refractive index difference ΔN between the first particles and the first binder satisfies the following formula (1), a mean particle diameter A of the first particles satisfies the following formula (2), and a content of the first particles is from 10 to 120 parts by mass with respect to 100 parts by mass of the first binder:
0<ΔN≦0.15 Formula (1)
0.5 μm≦A≦5.0 μm. Formula (2)

2. The light diffusion film for LED lighting according to claim 1, wherein the first particles included in the internal scattering layer have a particle size distribution (CV value) represented by the following formula (3) of 10% or less:
CV value=(particle diameter standard deviation)/(mean particle diameter)*100 (%). Formula (3)

3. The light diffusion film for LED lighting according to claim 1, wherein the first particles included in the internal scattering layer are organic particles having a crosslinking structure.

4. The light diffusion film for LED lighting according to claim 2, wherein the internal scattering layer comprises a crosslinking agent.

5. The light diffusion film for LED lighting according to claim 2, wherein the internal scattering layer comprises ultrafine particles comprising inorganic particles.

6. The light diffusion film for LED lighting according to claim 2, wherein a mean particle diameter B of the second particles included in the surface shaping layer is larger than the mean particle diameter A of the first particles included in the internal scattering layer.

7. The light diffusion film for LED lighting according to claim 2, wherein, in the following order from a substrate side, the internal scattering layer and the surface shaping layer are provided on one surface of the substrate.

8. The light diffusion film for LED lighting according to claim 7, wherein a layer having a refractive index lower than a mean refractive index of the substrate is provided on an external surface at a surface side of the substrate on which the surface shaping layer is not provided.

9. The light diffusion film for LED lighting according to claim 7, wherein a layer having a refractive index lower than a refractive index of the second particles included in the surface shaping layer is provided on an external surface of the surface shaping layer.

10. The light diffusion film for LED lighting according to claim 2, wherein the internal scattering layer is provided on one surface of the substrate, and the surface shaping layer is provided on the other surface of the substrate.

11. The light diffusion film for LED lighting according to claim 10, wherein a layer having a refractive index lower than a mean refractive index of the internal scattering layer is provided on an external surface of the internal scattering layer.

12. The light diffusion film for LED lighting according to claim 10, wherein a layer having a refractive index lower than a refractive index of the second particles included in the surface shaping layer is provided on an external surface of the surface shaping layer.

13. The light diffusion film for LED lighting according to claim 2, wherein among the second particles included in the surface shaping layer, particles having a mean particle diameter of 500 nm or more have a single peak in a particle size distribution.

14. The light diffusion film for LED lighting according to claim 2, wherein the substrate is a PET film.

15. The light diffusion film for LED lighting according to claim 2, wherein the first binder in the internal scattering layer and the second binder in the surface shaping layer each comprise at least one polymer selected from water-soluble polymers or water-dispersible polymers.

16. The light diffusion film for LED lighting according to claim 8, wherein a layer having a refractive index lower than a refractive index of the second particles included in the surface shaping layer is provided on an external surface of the surface shaping layer.

17. The light diffusion film for LED lighting according to claim 11, wherein a layer having a refractive index lower than a refractive index of the second particles included in the surface shaping layer is provided on an external surface of the surface shaping layer.

18. The light diffusion film for LED lighting according to claim 6, wherein among the second particles included in the surface shaping layer, particles having a mean particle diameter of 500 nm or more have a single peak in a particle size distribution.

19. The light diffusion film for LED lighting according to claim 18, wherein the first binder in the internal scattering layer and the second binder in the surface shaping layer each comprise at least one polymer selected from water-soluble polymers or water-dispersible polymers.
